(19) United States
(12) Patent Application Publication
(10) Pub. No.: US 2007/0001590 A1
(43) Pub. Date: Jan. 4, 2007

(54) Light source using organic electroluminescent device

(75) Inventors: Tomomi Tateishi, Kanagawa (JP); Kazuki Yamazaki, (US)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/474,479

(22) Filed: Jun. 26, 2006

(30) Foreign Application Priority Data
Jun. 29, 2005 (JP) 2005-190297

(51) Int. Cl. H01J 1/62; H01J 63/04

(52) U.S. Cl. 313/504; 313/512

(57) ABSTRACT

The present invention provides a light source including: a substrate, at least two or more linear organic electroluminescent devices arranged in parallel on the substrate; and a sealing member covering over the organic electroluminescent devices to seal them on the substrate; wherein the organic electroluminescent devices have an aspect ratio of 200 or more, and the sealing member has a length of 200 mm or more along the longitudinal direction of the organic electroluminescent devices and a thickness of 4 mm or more.

### CROSS-REFERENCE TO RELATED APPLICATION

This application claims priority under 35USC 119 from Japanese Patent Application Nos. 2005-190297 and 2006-123911, the disclosure of which are incorporated by reference herein.

### BACKGROUND OF THE INVENTION

1. Field of the Invention

The present invention relates to a light source (a light emitting source) that uses a linear organic electroluminescent device.

2. Description of the Related Art

Because an organic electroluminescent device (hereinafter, arbitrarily referred to as “an organic EL device” or “a light emitting device”) can obtain light emission with low voltage and high luminance, it has been viewed as promising for applications as various light sources such as, for example, a display device, a full color display, a backlight, and an illumination light source, and much development has been carried out.

As one organic EL device application, a technique of making the light emitting device an elongated linear light source has been disclosed (for example, see Japanese Patent Application Laid-Open (JP-A) No. 2003-51380).

Further, the organic EL device is a device in which an organic compound layer composed of an organic substance is provided between electrodes, and there is such a problem that if water is presented in the device, the water is decomposed into oxygen and hydrogen by electrolysis, and the generated oxygen and hydrogen reduce the durability of the device. For this reason, a method is adopted in which a manufactured device is sealed to block out oxygen and moisture in the air. Particularly, as a method of sealing a device, various sealing methods using various forms of sealing members have been devised (for example, see JP-A No. 2004-95408).

However, in the case of an organic EL device with a large aspect ratio (the length/width of an device), a structure, which is provided with the device, is sometimes distorted because of the size of the aspect ratio. In this case, particularly, when the device is used in an application as a light source, the position of the light source becomes non-uniform to impair the sharpness of an image.

Moreover, because a technique for sealing with certainly an organic EL device with a large aspect ratio (the length/width of an device) has not been provided yet, there is a problem with regard to the preservation durability of a device.

### SUMMARY OF THE INVENTION

The present invention has been made in consideration of the above-described circumstances and provides a light source (a luminescent light source) in which at least two or more linear organic electroluminescent elements with large aspect ratios are arranged parallel on a substrate, and which is a light source excellent in at least one of the preservation durability and the rigidity.

A first aspect of the invention is a light source having a substrate, at least two or more linear organic electroluminescent devices arranged in parallel on the substrate, and a sealing member covering over the luminescent elements to seal them on the substrate, wherein the organic electroluminescent devices have an aspect ratio of 200 or more, and the sealing member has a length of 200 mm or more along the longitudinal direction of the organic electroluminescent devices and has a thickness of 4 mm or more.

A second aspect of the invention is a light source according to the first aspect, wherein a difference in a linear thermal expansion coefficient between the substrate and the sealing member is less than 10×10⁻⁶. By making the difference in linear thermal expansion coefficient less than 10×10⁻⁶, distortion in the light source can be prevented and rigidity can be exhibited.

A third aspect of the invention is a light source according to the first or second aspect, wherein the sealing member is not in contact with the organic electroluminescent devices, an a space is formed between the sealing member and the substrate. By forming the space between the sealing member and the substrate, it is possible to improve the preservation durability of the device by placing a desiccant between the sealing agent and the substrate and to avoid trouble caused by contact between the sealing member and the organic electroluminescent device.

A fourth aspect of the invention is a light source according to any one of the first to third aspects, wherein the organic electroluminescent devices have a protective layer disposed thereon. By forming a protective layer over the organic electroluminescent devices, it is possible to further improve the preservation durability of the organic EL element and to improve the impact resistance simultaneously.

A fifth aspect of the invention is a light source according to any one of the first to fourth aspects, wherein the organic electroluminescent devices comprise plural light emitting units, each of which include a light emitting layer between an anode and a cathode, and a charge generating layer is formed between the plural light emitting units. Because the organic electroluminescent element has plural luminescent units between the anode and the cathode, each unit of which include a luminescent layer, and a charge generating layer is included between the plural luminescent units, the luminous efficiency of the organic EL element can be further improved.

A sixth aspect of the invention is a light source according to any one of the first to fourth aspects, wherein the organic electroluminescent devices comprise plural light emitting units between an anode and a cathode, each unit of which include a light emitting layer, and a conductive layer is included between the plural light emitting units. Because the organic electroluminescent device has plural luminescent units between the anode and the cathode, each unit of which include a luminescent layer, and a conductive layer is included between the plural luminescent units, the luminous efficiency of the organic EL device can be further improved.

### BRIEF DESCRIPTION OF DRAWINGS

FIG. 1A is a top view of an embodiment of the present invention;

FIG. 1B is a cross-sectional view along the A-A line of FIG. 1A;

FIG. 2 is a schematic view showing an example of an organic EL device, which can be applied to the light source of the present invention, in which the organic EL devices have a charge generating layers between plural light emitting units; and

FIG. 3 is a schematic view showing an example of an organic EL device, which can be applied to the light source of the present invention, in which the organic EL devices have a conductive layer s between plural light emitting units.

### DETAILED DESCRIPTION OF THE INVENTION

Hereinafter, the light source of the present invention will be described in detail.

The light source is a light source having a substrate, at least two or more linear organic electroluminescent devices arranged in parallel on the substrate, and a sealing member covering over the organic electroluminescent devices to seal them on the substrate, wherein the organic electroluminescent devices have an aspect ratio of 200 or more, and the sealing member has a length of 200 mm or more along in the longitudinal direction of the organic electroluminescent devices and has a thickness of 4 mm or more.

In the invention, it is necessary that the sealing member has a length of 200 mm or more along the longitudinal direction of the organic electroluminescent devices and has a thickness of 4 mm or more.

The thickness of the sealing member is preferably 4 mm to 20 mm, and more preferably 4 mm to 10 mm.

The length of the sealing member along the longitudinal direction of the organic EL device is 200 mm or more and is set so as to cover the all of the organic EL devices according to the number of the devices to be arranged.

Because the sealing member can seal with certainly the part (a pixel part) formed by the two or more linear organic EL devices due to making the length along the longitudinal direction of the organic EL devices 200 mm or more and the thickness 4 mm or more, whereby penetration of moisture, oxygen, and the like from outside is prevented, the preservation durability of the devices is improved. Moreover, because the whole structure of the light source exhibits rigidity, the light source is not distorted, and penetration of moisture, oxygen, and the like from the outside can be prevented even when the width of the pixel part is narrow (for example, the pixel part is formed to be rectangular).

From the viewpoint of preventing distortion and exhibiting rigidity of the light source, the difference in linear thermal expansion coefficient between the substrate and the sealing member is preferably less than 10×10⁻⁶, more preferably less than 7×10⁻⁶, and further preferably less than 3×10⁻⁶. Although temperature for measuring the linear thermal expansion coefficient is not particularly limited, it is preferably in a range of temperature at which the light source is used, that is, preferably −20° C. to 100° C., more preferably 0° C. to 100° C., further preferable to be 20° C. or more to 100° C. or less, particularly preferably 20° C. to 80° C., and most preferably 20° C. Here, although the linear thermal expansion coefficient can be measured based on known measuring methods, the coefficient is measured in conformity with a method described in “Japanese Industrial Standards (JIS)” or the like, according to the material. For example, it is suitable to apply the measuring method described in JIS R3102 (1995) for glass materials, the method described in JIS Z2285 (2003) for metallic materials, and the method described in JIS K7197 (1991) for plastics materials.

The materials of the sealing member are not particularly limited as long as they meet the requirement of the above-mentioned linear thermal expansion coefficient, and example thereof include inorganic materials such as soda glass and non-alkali glass, metallic materials such as stainless steel and aluminum alloy, polyesters such as polyethylene terephthalate, polybutylene terephthalate and polyethylene naphthalate, high-molecular weight materials such as polyethylene, polycarbonate, polyether sulfone, polyallylate, allyldiglycol carbonate, polyimide, polycyclo olefin, norbornene resin, polychlorotrifluoroethylene, Teflon (registered trademark), and polytetrafluoroethylene-polyethylene copolymer, and the like. Such materials can be appropriately selected and used in combination with a substrate.

The sealing member is a member that covers over organic EL devices to seal them on a substrate, and besides being reverse-concave, for example, ribs or concavity and convexity can be provided on the surface of the substrate side or the surface of the opposite side of the member to further increase rigidity by improving a cross-sectional secondary moment.

The materials of the substrate are not particularly limited, and examples thereof include inorganic materials such as zirconia stabilized yttrium and glass, polyesters such as polyethylene terephthalate, polybutylene terephthalate and polyethylene naphthalate, and high-molecular weight materials such as polyethylene, polycarbonate, polyether sulfone, polyallylate, allyldiglycol carbonate, polyimide, polycyclo olefin, norbornene resin, polychlorotrifluoroethylene, Teflon (registered trademark), and polytetrafluoroethylene-polyethylene copolymer.

The range of the aspect ratio of the organic EL device in the invention is required to be 200 or more, but the upper limit is not particularly limited and is preferably 16,000 or less. The range of the aspect ratios is preferably 300 or more to 16,000 or less, more preferably 500 or more to 16,000 or less, and further preferably 1,000 or more to 10,900 or less, particularly preferably 2,000 or more to 10,000 or less, and most preferably 5,000 or more to 10,000 or less.

Here, in the specification, the aspect ratio is a value obtained by dividing the length of the organic EL device in the longitudinal direction by the length thereof in the direction perpendicular to the longitudinal direction.

Although the length of the organic EL device in the longitudinal direction can be suitably set according to the applied form of the device, from the viewpoint of easily providing and manufacturing a planer light source having a large area, it is preferably 100 mm to 2,000 mm, and more preferably 100 mm to 1,000 mm.

The light source of the invention is a light source having at least two or more linear organic electroluminescent devices with large aspect ratios arranged in parallel on a substrate. From the viewpoint of providing a planer light source having a large area, it is preferable to arranged in parallel 100 or more of organic EL devices, and further preferable to arranged in parallel 200 or more. The width of the linear organic EL device is preferably 5 μm to 1 mm from the viewpoint of image sharpness, more preferably 10 μm to 500 μm, and particularly preferably 10 μm to 100 μm. The spacing of the linear organic EL devices is preferably 5 μm to 1 mm from the viewpoint of image sharpness, more preferably 10 μm e to 500 μm, and particularly preferably 10 μm to 100 μm.

The method of configuring a planar light source by arranging a number of linear light sources in parallel as in the invention can form a planar light source more easily and also provides the circuit, power source, and the like for driving the light source with a simple configuration compared with a method of configuring a planar light sources in a matrix in the directions of X and Y. Further, in the light source of the invention, luminance gradation can also be controlled by controlling the lighting line frequency of the linear organic EL devices, and visual effect can also be obtained by making the linear organic EL devices emit light sequentially at the right time.

The organic EL device in the invention comprises at least one organic compound layer including an organic light emitting layer (hereinafter, sometimes simply referred to as “a light emitting layer”) between a pair of electrodes. Other than the light emitting layer, the organic EL device may have a hole injection layer, a hole transport layer, an electron injection layer, an electron transport layer, and the like.

One preferable embodiment of the organic EL device in the invention is an organic EL device in which plural light emitting units between the anode and the cathode, each of which including a light emitting layer, are included and a charge generating layer is included between the light emitting units. Moreover, another preferable embodiment of the organic EL device in the invention is an organic EL device in which plural light emitting units between the anode and the cathode, each of which including a light emitting layer, are included and a conductive layer is included between the light emitting units.

The organic EL device can be prepared, for example, in such a way that after an electrode is formed on the substrate and an insulating layer is formed on the electrode, the insulating layer corresponding to the part where an organic EL device is intended to be formed is removed by etching or the like, and then an organic compound layer and an electrode are further formed sequentially.

The organic EL device may further have a protective layer thereon.

Each component constituting the organic EL device (such as a electrode, an organic compound layer, a protective layer or the like) will be further described in detail below.

Sealing can be carried out in such a way that after the organic EL devices are formed on a substrate, a sealant is applied on a sealing member and/or an outer periphery of the substrate, and the sealing member is placed thereon to adhere the substrate and the sealing member.

As a sealant, known adhesives used in sealing an organic EL device such as ultraviolet curing resins, photocuring resins, and thermosetting resins can be used.

In the invention, it is preferable that the sealing member is not contact with the organic electroluminescent devices and forms a space between the substrate and the sealing member itself.

In the hollow space, a moisture absorbent material (a desiccating agent) or an inert liquid may be enclosed. The moisture absorbent material is not particularly limited, and examples thereof include barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite, and magnesium oxide. The inert liquid is not particularly limited, and example thereof include paraffin, liquid paraffin, fluorinated solvents such as perfluoroalkane, perfluoroamine, and perfluoroether, chlorinated solvents, and silicone oil.

Moreover, the space may be divided with a dividing member, which is in contact with the sealing member and the substrate to divide the space.

An embodiment of a light source of the invention will be described below; however, the invention is not limited thereto.

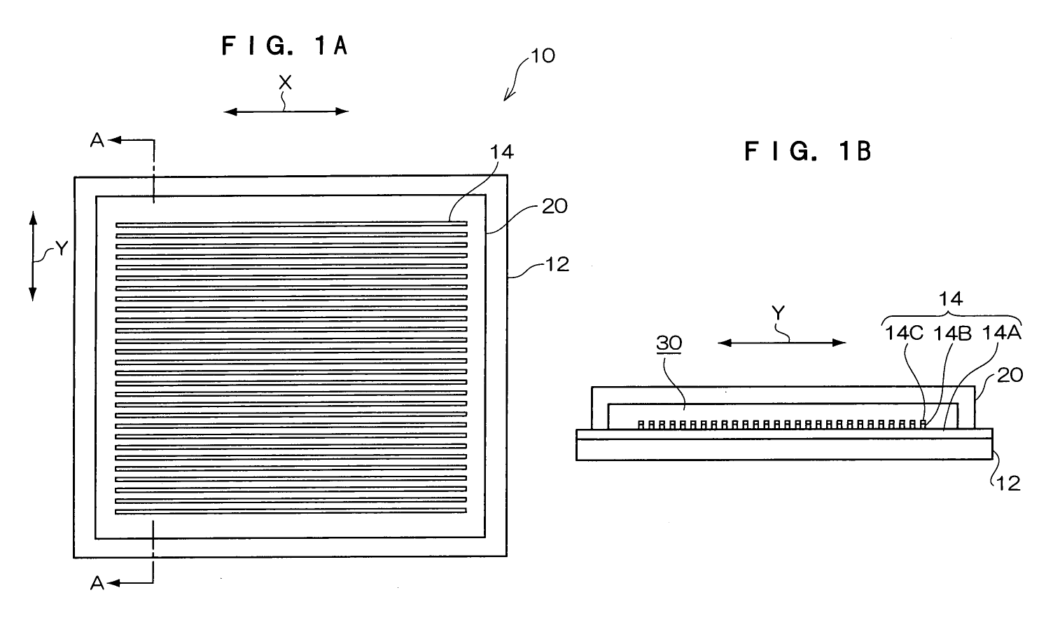

FIG. 1A is a top view of a light source of the invention and FIG. 1B is a cross-sectional view along the line A-A of FIG. 1A.

In FIG. 1A, a light source 10 includes a substrate 12, organic EL devices 14 arranged in parallel on the substrate 12, and a sealing member 20.

The organic EL devices 14 are arranged in parallel along the Y direction of the substrate 12 so that the longitudinal direction thereof is along the edge in the X direction.

As shown by FIG. 1B, each of the organic EL devices 14 is composed of the organic compound layer 14B between the electrode 14A provided on the substrate 12 and the electrode 14C, which is a opposite electrode.

The sealing member 20 is a reverse-concave sealing member and covers all of the organic EL devices 14 arranged in parallel to seal them on the substrate 12.

Moreover, in this embodiment, a space 30 is by formed by the substrate 12 and the sealing member 20.

<Organic EL Device>

Hereinafter, the organic EL device in the invention will be described.

The organic EL device in the invention is, as described above, a linear device having aspect ratio of 200 or more, and at least two or more of the devices are arranged in parallel on the substrate.

The organic EL device in the invention has the anode and the cathode on the substrate and has at least one organic compound layer that contains the light emitting layer between the electrodes. In view of the character of the light emitting device, at least one electrode of the anode and the cathode is preferable to be transparent.

In an embodiment of the laminated structure of the organic compound layer in the invention, a hole transport layer, a light emitting layer, and an electron transport layer are formed from the anode side. Further, a charge blocking layer or the like may be formed between the hole transport layer and the light emitting layer, or between the light emitting layer and the electron transport layer. A hole injection layer may be disposed between the anode and the hole transport layer, and the electron injection layer may be disposed between the cathode and the electron transport layer. In addition, the light emitting layer may be one layer or the light emitting layer may be divided into a first light emitting layer, a second light emitting layer, a third light emitting layer. Further, each layer may be further divided into plural second layers.

-Light Emitting Layer-

The light emitting layer receives the hole from the anode, the hole injection layer or the hole transport layer and receives the electron form the cathode, the electron injection layer or the electron transport layer upon application of the electric field, thereby providing a field where the hole and the electron are recombined so as to emit a light.

The light emitting layer in the invention may be composed of only a luminescence materials or may be composed of the mixed layer having a host material and a luminescent material mixed therein. The luminescent material may be a fluorescence material or a phosphorescence material. One luminescent material may be used alone or two or more luminescent materials may be used in combination.

The host material is preferable to be an charge transport material. On host material may be used alone or two or more host materials may be used in combination. Example thereof include a structure in which a host material with a electron transportability is mixed with a host material with a hole transportability. Further, the light emitting layer may include a material that does not emit a light without the charge transportability.

In addition, the light emitting layer may be one layer or more layers each layer may emit a light of a different color, respectively.

Examples of the fluorescence luminescent materials to be used in the invention are not particularly limited and appropriately selected from the known materials. For example, the materials described in the paragraph [0027] of JP-A No. 2004-146067, the paragraph [0057] of JP-A No. 2004-103577 or the like may be used, but the invention is not limited thereto.

In addition, the phosphorescence luminescent materials to be used in the invention are not particularly limited and appropriately selected from the known materials. For example, the materials described in the paragraph [0051] to [0057] of JP-A No. 2004-221068 or the like may be used, but the invention is not limited thereto.

In order to improve the luminous efficiency, the organic EL device in the invention may have a structure in which plural light emitting units between an anode and a cathode, each of which include a light emitting layer, are included and a charge generating layer is included between the plural light emitting units.

The charge generating layer has a function to generate a charge (holes and electrons) upon application of the electric field, together with a function to inject the generated charge into the layer adjacent to the charge generating layer.

The charge generating layer is preferably composed as a conductive layer.

The material forming the charge generating layer may be any material having the above-mentioned functions and it may be formed form a single compound or a plurality of compounds.

Specifically, the material may be a material having conductivity or having semiconductivity such as a doped organic layer or having electrical isolation. For example, examples of the materials include those described in JP-A Nos. 11-329748, 2003-272860, and 2004-39617.

Further, specific examples include a transparent conductive material such as ITO and IZO (indium zinc oxide); conductive organic materials such as fullerenes (for example C₆₀) and an oligothiophene; a conductive organic material such as metallic phthalocyanines, metal-free phthalocyanines, metalloporphyrins, and metal-free porphyrins; a metallic material such as Ca, Ag, Al, alloy of Mg:Ag, alloy, Al:Li alloy, and Mg:Li alloy; a hole conductive material, an electron conductive material, and combinations thereof.

Examples of the hole conductive material include the hole transport materials such as 2-TNATA and NPD doped with an oxidizing agent having an electron withdrawing property such as F4-TCNQ, TCNQ, and FeCl₃, P-type conductive polymers, and P-type semiconductor or the like. The electron conductive material may include the electron transport organic Material doped with a metal or a metallic compound having a work function of less than 4.0 eV, an N-type conductive polymer, and an N-type semiconductor or the like. Example of the N-type semiconductor may include an N-type Si, an N-type CdS, and an N-type ZnS or the like. Examples of the P-type semiconductors may include a P-type Si, a P-type CdTe, and a P-type CuO or the like.

Further, as the charge generating layer, an electrical insulating material such as V₂O₅ may also be used.

The charge generating layer may be a single layer or multilayer. Example of the multilayer structure include a structure in which a hole conductive material and a conductive material such as a transparent electrical conductive material and a metallic material, or an electron conductive material are laminated; and a structure in which the above-described hole conductive materials and the electron conductive materials are laminated.

With respect to the charge generating layer, a film thickness and a material are preferably selected so that the transmission factor of a visible light is 50% or more in addition, the film thickness is not particularly limited, however, it is preferably 0.5 to 200 nm, more preferably 1 to 100 nm, still more preferably 3 to 50 nm, and still further preferably 5 to 30 nm.

A method of forming the charge generating layer is not particularly limited and a method of forming the organic compound layer may be applied.

The charge generating layer is formed between plural light emitting units; however, at the anode side of the cathode and the side of the charge generating layer, the charge generating layer may contain a material having to inject charge into the adjacent layer. In order to improve a performance of injecting the electron into the layer adjacent to the anode side, for example, an electron injection compound such as BaO, SrO, Li₂O, LiCl, LiF, MgF₂, MgO, and CaF₂ may be laminated at the side of the anode of the charge generating layer.

In addition to the above-described materials, the charge generating layer can be selected from those description in each specification of JP-A No. 2003-45676, U.S. Pat. Nos. 6,337,492, 6,107,734, and 6872472 or the like.

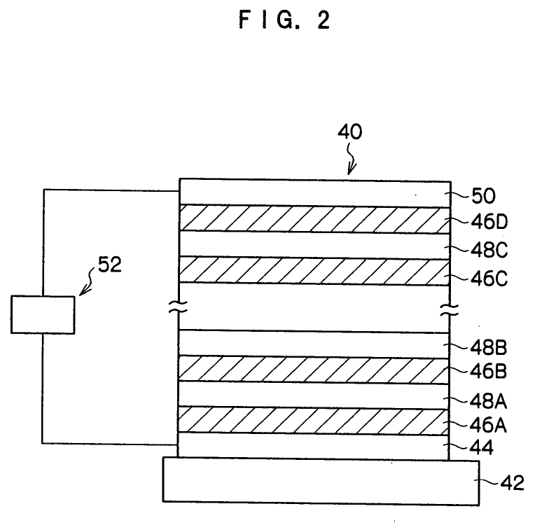

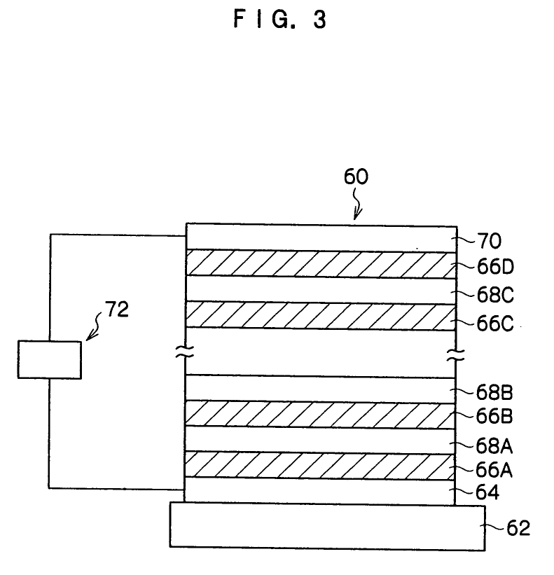

FIG. 2 is a schematic view of an example of an organic EL device having charge generating layers between plural light emitting units, which is used as an organic EL in the invention. In addition, FIG. 3 is a schematic view of an example of an organic EL device having conductive layers between plural light emitting units, which is used as an organic EL in the invention. The invention does not limited thereto.

As shown FIG. 2, an organic EL device in a light source of the invention is designated as 40. The organic EL device 40 comprises a substrate 42 on which an anode 44 and a cathode 50 are formed, and between the anode and the cathode, light emitting units 46A, 46B, 46C, and 46D, each of which containing a light emitting layer, and between the light emitting units, are provided charge generating layers 48A, 48B, and 48C. The anode 44 and the cathode 50 are connected through the power source 52.

Regarding the light emitting units 46A, 46B, 46C, and 46D, each of which containing a light emitting layer, the units may be the same composition as each other or different. Regarding the charge generating layers 48A, 48B, and 48C, the layers may be the same composition as each other or different.

As shown FIG. 3, an organic EL device in a light source of the invention is designated as 60. The organic EL device 60 comprises a substrate 62 on which an anode 64 and a cathode 70 are formed, and between the anode and the cathode, light emitting units 66A, 66B, 66C, and 66D, each of which containing a light emitting layer, and between the light emitting units, are provided conductive layers 68A, 56B, and 68C. The anode 64 and the cathode 70 are connected through the power source 72.

Regarding the light emitting units 66A, 66B, 66C, and 66D, each of which containing a light emitting layer, the units may be the same composition as each other or different. Regarding the conductive layers 68A, 56B, and 68C, the layers may be the same composition as each other or different.

Example of the other component part such as the substrate, the electrode, each organic layer, and other layers in the organic EL device in the invention include, for example, those described in paragraphs [0013] to [0082] of JP-A No. 2004-221068; paragraphs [0017] to [0091] of JP-A No. 2004-214178; paragraphs [0024] to [0035] of JP-A No. 2004-146067; paragraphs [0017] to [0068] of JP-A No. 2004-103577; paragraphs [0014] to [0062] of JP-A No. 2003-323987; paragraphs [0015] to [0077] of JP-A No. 2002-305083; paragraphs [0008] to [0028] of JP-A No. 2001-172284; paragraphs [0013] to [0075] of JP-A No. 2000-1860941; paragraphs [0016] to [0118] of Japanese Patent Application National Publication (Laid-Open) No. 2003-515897, but the invention is not limited to thereto.

As a driving method of the organic EL device in the invention, the driving methods described in each of JP-A Nos. 2-148687, 6-301355, 5-29080, 7-134558, 8-234685, and 8-241047, Japanese Patent No. 2784615, U.S. Pat. Nos. 5,828,429 and 6,023,308 or the like can be applied.

The organic EL device in the invention is preferable to have a protective layer on the device to prevent the penetration of moisture and oxygen. The materials included in the protective layer may have the function of controlling the entering of those to promote the device deterioration such as moisture and oxygen in the device. The specific examples of the materials include metals such as In, Sn, Pb, Au, Cu, Ag, Al, Ti, and Ni, metallic oxides such as MgO, SiO, SiO₂, Al₂O₃, GeO, NiO, CaO, BaO, Fe₂O₃, Y₂O₃, and TiO₂, metallic fluorides such as MgF₂, LiF, AlF₃, and CaF₂, nitrides such as SiN_{X} and SiO_{X}N_{Y}, polyethylene, polypropylene, polymethyl methacrylate, polyimide, polyurea, polytetrafluoroethylene, polychlorotrifluoroethylene, polydichlorodifluoroethylene, copolymer of chlorotrifluoroethylene and dichlorodifluoroethylene, copolymer obtained by copolymerizing the monomer mixture containing tetrafluoroethylene and at least one kind of comonomer, fluorine-containing copolymer having cyclic structure in the copolymer main chain, water-absorbing substances having water absorption coefficient of 1% or more, and dampproof substances having water absorption coefficient of 0.1% or less.

The methods for forming the protective layer are not particularly limited and the example of the methods include, a vacuum evaporation method, a sputtering method, a reactive sputtering method, a MBE (molecular beam epitaxy) method, an ionized cluster beam method, an ion plating method, a plasma polymerization method (a high-frequency excitation ion plating method), a plasma CVD method, a laser CVD method, a thermal CVD method, a gas source CVD method, a coating method, a printing method, and a transfer method can be applied.

The light source of the invention is not particularly limited of its use, and it can be suitably used in various forms. For example, when the light source is used as a read-only light source, it becomes possible to read an image (an electronic latent image) in high-resolution without needing the scanning machine mechanism. In addition, when the light source is used as a display sigh light source, the visual effect is improved by line sequential lighting or random lighting of the line pixels. Further, because the light source is high-resolution and high luminescence, it becomes possible to control the luminance gradation by the lighting line frequency and the power supply circuit, which does not need current/voltage control.

Hereinafter, the invention will be specifically described by examples. However, the invention should not be limited to these.

### EXAMPLES

### Example 1

On the ITO substrate (soda glass, linear thermal expansion coefficient: 9×10⁻⁶) of 465×440×0.7 mm, pixels of 430 mm×50 μm (aspect ratio: 8600), and the pixel part (430×430 mm) that had been separated with partition walls so as to be a pitch of 100 μm between pixels were prepared by an organic EL device of the following layer configuration (A). After a desiccating agent, HD-S (manufactured by Dynic Corporation) was put in the center part on the organic EL device side of the sealing member (soda glass, linear thermal expansion coefficient: 9×10⁻⁶, 433 mm×433 mm×5 mm, the depth dug in glass of inner organic EL device side: 1 mm, the overlap width part in the periphery: 1 mm width), a sealant, XNR5516-HV-B1 (manufactured by Nagase & Co., Ltd.) was applied to the overlap width part in the periphery and the sealing member was placed on the substrate so as to cover the pixel part, and then the sealant was cured with 6 J/cm² (365 nm) using a mercury lamp of 400 W while pressurizing the sealing member so that the gap with the substrate might be 12 μm and the sealing member was sealed.

The light source in Example 1 was manufactured as mentioned above.

<Layer Configuration (A)>

| | |
|---|---|
| Anode: | ITO (substrate) |
| Hole injection layer: | CuPc (copper phthalocyanine) [10 nm] |
| Hole transport layer: | NPD [30 nm] |
| Light emitting layer: | Mixed layer of mCP (95%) and Firpic (5%) |
| | [30 nm] |
| Hole block layer: | Balq₂ [10 nm] |
| Electron transport layer: | Alq [40 nm] |
| Electron injection layer: | LiF [0.5 nm] |
| Cathode: | Al [100 nm] |

In the following, the structures of CuPc, NPD, mCP, Firpic, Balq₂, and Alq₃ are shown.

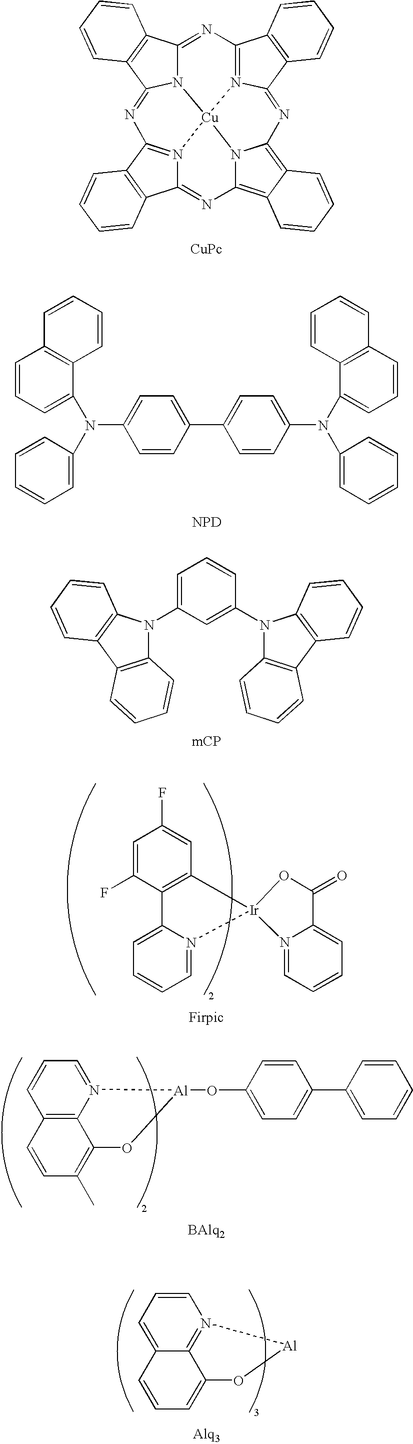

### Example 2

On the ITO substrate (soda glass, linear thermal expansion coefficient: 9×10⁻⁶) of 275×310×0.7 mm, pixels of 240 mm×25 μm (aspect ratio: 9600), and the pixel part (240×300 mm) that had been separated with partition walls so as to be a pitch of 50 μm between pixels were prepared by an organic EL device of the above-described layer configuration (A). After a desiccating agent, HD-S (manufactured by Dynic Corporation) was put in the center part on the organic EL device side of the sealing member (soda glass, linear thermal expansion coefficient: 9×10⁻⁶, 243 mm×303 mm×5 mm, the depth dug in glass of inner organic EL device side: 1 mm, the overlap width part in the periphery: 1 mm width), a sealant, XNRS5516-HV-B1 (manufactured by Nagase & Co., Ltd.) was applied to the overlap width part in the periphery and the sealing member was placed on the substrate so as to cover the pixel part, and then the sealant was cured with 6 J/cm² (365 nm) using a mercury lamp of 400 W while pressurizing the sealing member so that the gap with the substrate might be 12 μm and the sealing member was sealed.

The light source in Example 2 was manufactured as mentioned above.

### Example 3

The light source in Example 3 was manufactured in the same manner as that in Example 1, except for using ITO substrate (non-alkali glass, linear thermal expansion coefficient: 3×10⁻⁶) in place of the ITO substrate in Example 1.

### Example 4

The light source in Example 4 was manufactured in the same manner as that in Example 1, except for using a sealing member (SUS430, linear thermal expansion coefficient: 11×10⁻⁶) in place of the sealing member in Example 1.

### Comparative Example 1

The light source in Comparative Example 1 was manufactured in the same manner as that in Example 1, except for using a sealing member (soda glass, linear thermal expansion coefficient: 9×10⁻⁶, 433 mm×433 mm×1.1 mm, the depth dug in glass of inner organic EL device side: 0.5 mm, the overlap width part in the periphery: 1 mm width) in place of the sealing member in Example 1.

### Comparative Example 2

The light source in Comparative Example 2 was manufactured in the same manner as that in Example 1, except for using a sealing member (aluminum, linear thermal expansion coefficient: 25×10⁻⁶) in place of the sealing member in Example 1.

The following evaluation was conducted using the obtained each light source.

The gap between the center part and the edge in the light source was measured. The measurement was carried out in such a manner that after the substrate side of each light source was placed in contact with the top surface of the surface plate (surface plate temperature 20° C.) of 2 μm or less in flatness, the gap between the center part and the edge (deflection) in each light source was measured with a laser micro gauge. Here, the flatness means the height of the undulation of the surface in the prescribed range of the surface plate. The results are shown in Table 1.

TABLE 1

| | | | | Difference in | |
|---|---|---|---|---|---|
| | | | | thermal expansion | |
| | | | | coefficient | Gap between the |
| | | | | between the | center part and |
| | Aspect ratio | | Thickness of the | substrate and the | the edge in the |
| | of the pixel | Dimensions (mn) | sealing member | sealing member | light source |
| Example 1 | 8600 | 465 × 440 | 4 mn | 0 | 0.72 mn |
| Example 2 | 9600 | 275 × 310 | 4 mn | 0 | 0.58 mn |
| Example 3 | 8600 | 465 × 440 | 4 mn | 6 × 10⁻⁶ | 0.95 mn |
| Example 4 | 8600 | 465 × 440 | 4 mn | 3 × 10⁻⁶ | 0.88 mn |
| Comparative | 8600 | 465 × 440 | 1 mn | 0 | 3.04 mn |
| Example 1 | | | | | |
| Comparative | 8600 | 465 × 440 | 4 mn | 16 × 10⁻⁶ | 1.95 mn |
| Example 2 | | | | | |

As shown in Table 1, the light sources in the examples have been confirmed to be excellent in image sharpness and preservation durability because of no distortion.

Moreover, the organic EL devices in Examples 1 to 4 can be applied to the organic EL devices such as described in FIG. 2 or FIG. 3, by forming plural light emitting units, each of which has layer configuration A, and forming charge generating layers or conductive layers between the plural light emitting units.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indication to be incorporated by reference.

What is claimed is:

1. A light source comprising: a substrate, at least two or more linear organic electroluminescent devices arranged in parallel on the substrate; and a sealing member covering over the organic electroluminescent devices to seal them on the substrate; wherein the organic electroluminescent devices have an aspect ratio of 200 or more, and the sealing member has a length of 200 mm or more along the longitudinal direction of the organic electroluminescent devices and has a thickness of 4 mm or more.

2. The light source of claim 1, wherein a difference in a linear thermal expansion coefficient between the substrate and the sealing member is less than 10×10⁻⁶.

3. The light source of claim 1, wherein the sealing member has a thickness of 4 mm to 20 mm.

4. The light source of claim 1, wherein the organic electroluminescent devices have an aspect ratio of 300 to 16000.

5. The light source of claim 1, wherein the organic electroluminescent devices have a length of 100 mm to 2000 mm along the longitudinal direction of the devices.

6. The light source of claim 1, wherein the organic electroluminescent devices have a width of 5 μm to 1 mm.

7. The light source of claim 1, wherein the organic electroluminescent devices have an aspect ratio of 300 to 16000, a length of 100 mm to 2000 mm along the longitudinal direction of the devices and a thickness of 4 mm to 20 mm.

8. The light source of claim 1, wherein 100 or more of the linear organic electroluminescent devices are arranged in parallel on the substrate.

9. The light source of claim 1, wherein the sealing member is not in contact with the organic electroluminescent devices, an a space is formed between the sealing member and the substrate.

10. The light source of claim 9, wherein a moisture absorbent material or an inert liquid is enclosed in the space.

11. The light source of claim 9, wherein the space is divided by a dividing member which contacts the sealing member and the substrate.

12. The light source of claim 1, wherein the organic electroluminescent devices have a protective layer disposed thereon.

13. The light source of claim 1, wherein the organic electroluminescent devices comprise plural light emitting units between an anode and a cathode, each unit of which include a light emitting layer, and a charge generating layer is included between the plural light emitting units.

14. The light source of claim 1, wherein the organic electroluminescent devices comprise plural light emitting units between an anode and a cathode, each unit of which include a light emitting layer, and a conductive layer is included between the plural light emitting units.
